(19) United States
(12) Patent Application Publication
(10) Pub. No.: US 2015/0281000 A1
(43) Pub. Date: Oct. 1, 2015

(54) MANAGEMENT SYSTEM AND DEVICE

(71) Applicant: FUJITSU LIMITED, Kawasaki-shi (JP)

(72) Inventors: Tadashi IYAMA, Kawasaki (JP); Kenichirou SHIMOGAWA, Numazu (JP)

(73) Assignee: FUJITSU LIMITED, Kawasaki-shi (JP)

(21) Appl. No.: 14/626,993

(22) Filed: Feb. 20, 2015

(30) Foreign Application Priority Data
Mar. 31, 2014 (JP) 2014-072145

(51) Int. Cl. H04L 12/24; H04L 29/08; H04L 12/26

(52) U.S. Cl. CPC H04L 41/14; H04L 43/08; H04L 41/24; H04L 67/1097

(57) ABSTRACT

A management system including plural managed devices, a management device that manages each of the plural managed devices, and a storage device that is provided separately from the plural managed devices and the management device, and is commonly employed by the plural managed devices and the management device. The plural managed devices each respectively write status data, indicating a status of the respective managed device, to the storage device at a specific timing. The management device manages the status of each of the managed devices by verifying the status data written to the storage device at a timing according to the specific timings.

### CROSS-REFERENCE TO RELATED APPLICATION

This application is based upon and claims the benefit of priority of the prior Japanese Patent Application No. 2014-072145, filed on Mar. 31, 2014, the entire contents of which are incorporated herein by reference.

### FIELD

The embodiments discussed herein are related to a management system, a management device, a managed device, and a non-transitory recording medium storing a management program.

### BACKGROUND

Server management systems such as those provided to businesses include a management server and plural servers. Each of the servers is a data processing device that executes the business processing of the business. If one of the servers stops then damage is caused to business execution. In order to prevent damage occurring to business execution, a management server manages each of the servers. More specifically, the management server ascertains the operational status of each of the servers, and predicts the occurrence of malfunctions. More precisely, the management server acquires data indicating the operational status separately from each of the servers. The management server sets an execution condition for processing separately in each of the servers. Examples of the execution condition include a condition for moving a virtual machine (VM) to a server that does not have a high CPU utilization when the CPU utilization of the current server is high, for example 80% or higher.

However, in methods such as the management server acquiring data indicating the operational status of each of the servers individually, there is a deterioration in management performance of the management server in cases such as cloud computing in which a management server manages many servers. This is due to the load on the management server increasing when the management server communicates with each of the servers, and it taking time to process data acquired from all the servers.

There is accordingly a proposal for technology such as the following as conventional technology to reduce the load on a management server.

For example, there is technology to manage each server by grouping plural servers into an uppermost layer, a middle layer and a lowermost layer. In such technology a representative server of the plural servers in the middle layer manages the plural servers in the lowermost layer. The representative server of the plural servers in the uppermost layer manages the plural servers in the middle layer. Then the uppermost representative server acquires operation data for each of the servers from the plural servers in the uppermost layer, and from the representative server in the uppermost layer, and transmits the operation data acquired for each of the servers to the management server. In the conventional technology, since the management server only communicates with the uppermost representative server, the load on the management server is reduced.

Moreover, there is also technology in which plural servers are divided into plural groups, and in each of the groups, each of the plural servers belonging to the same group manage each other. The management server then communicates with one of the servers in each of the groups.

### RELATED PATENT DOCUMENTS

Japanese Laid-Open Patent Publication No. 2009-171476

Japanese Laid-Open Patent Publication No. 2011-191844

### SUMMARY

According to an aspect of the embodiments, a management system includes plural managed devices, a management device that manages each of the plural managed devices, and a storage device that is provided separately from the plural managed devices and the management device, and is commonly employed by the plural managed devices and the management device. The plural managed devices each respectively write status data, indicating a status of the respective managed device, to the storage device at a specific timing. The management device manages the status of each of the managed devices by verifying the status data written to the storage device at a timing according to the specific timings.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic configuration of a server management system of an exemplary embodiment;

FIG. 2 is a block diagram illustrating a schematic configuration of a management server;

FIG. 3 is a block diagram illustrating a schematic configuration of a managed server;

FIG. 4 is a diagram illustrating an example of an action table;

FIG. 5 is a diagram illustrating an example of a server management table;

FIG. 6 is a block diagram illustrating a functional configuration of a management server;

FIG. 7 is a block diagram illustrating a functional configuration of a managed server;

FIG. 8 is a diagram illustrating an example of a management program stored on an HDD of a management server;

FIG. 9 is diagram illustrating an example of a managed target program stored on an HDD of a managed server;

FIG. 10 is a flowchart illustrating an example of presence verification processing executed by a management server;

FIG. 11 is a flowchart illustrating an example of presence data write processing executed by a managed server;

FIG. 12 is a flowchart illustrating an example of operation instruction processing for a managed server executed by a management server;

FIG. 13 is a flowchart illustrating an example of presence verification processing of step 142 of FIG. 12;

FIG. 14A is a diagram illustrating writing an operation instruction from a management server to a common DB;

FIG. 14B is a diagram illustrating an example of an action table for the case of FIG. 14A;

FIG. 15A is a diagram illustrating acquisition of an operation instruction by a managed server;

FIG. 15B is a diagram illustrating an example of an action table for the case of FIG. 15A;

FIG. 16A is a diagram illustrating an operation error occurring in a managed server that acquired an operation instruction;

FIG. 16B is a diagram illustrating an example of an action table for the case of FIG. 16A;

FIG. 17A is a diagram illustrating taking over of an operation instruction by another management server;

FIG. 17B is a diagram illustrating an example of an action table for the case of FIG. 17A;

FIG. 18A is a diagram illustrating a case in which operation errors have occurred in all of the managed servers in the same group;

FIG. 18B is a diagram illustrating an example of an action table for the case of FIG. 18A;

FIG. 19 is a flowchart illustrating an example of instruction execution processing executed by a managed server;

FIG. 20 is flowchart illustrating an example of designated execution processing at step 206 of FIG. 19;

FIG. 21 is a flowchart illustrating an example of undesignated execution processing at step 208 of FIG. 19; and

FIG. 22 is a flowchart illustrating an example of server addition processing executed by a management server.

### DESCRIPTION OF EMBODIMENTS

Detailed explanation follows regarding exemplary embodiment of technology disclosed herein, with reference to the drawings.

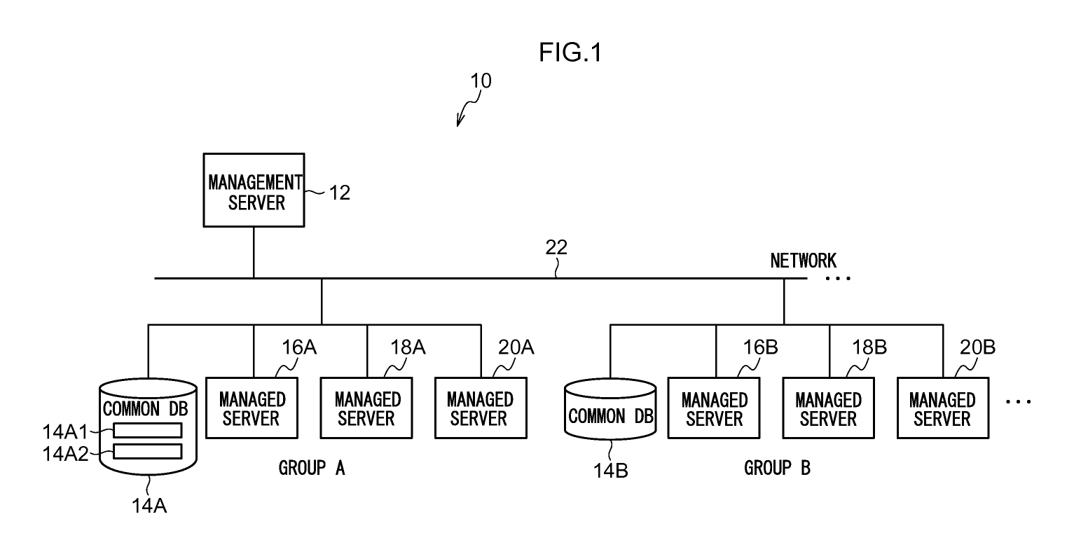

FIG. 1 is a block diagram of a server management system 10 of an exemplary embodiment. As illustrated in FIG. 1, the server management system 10 includes a management server 12. The server management system 10 includes plural managed servers connected to the management server 12 through a network 22. The plural managed servers are grouped into plural groups A, B, etc. Each of the groups A, B, etc. have the same configuration, and so explanation follows regarding configuration of group A, and explanation regarding group B etc. will be omitted. Group A includes plural, for example three, managed servers 16A, 18A, 20A. The server management system 10 includes, for each of the groups, plural common databases (DB) accessible by the plural managed servers in the group. For example, the common DB 14A provided corresponding to the group A is connected to the management server 12 and to the three managed servers 16A, 18A, 20A through the network 22. The common DB 14A may be provided by separate server, or may be separate storage employ as the common DB 14A. The common DB 14A is an example of a “storage device” of technology disclosed herein.

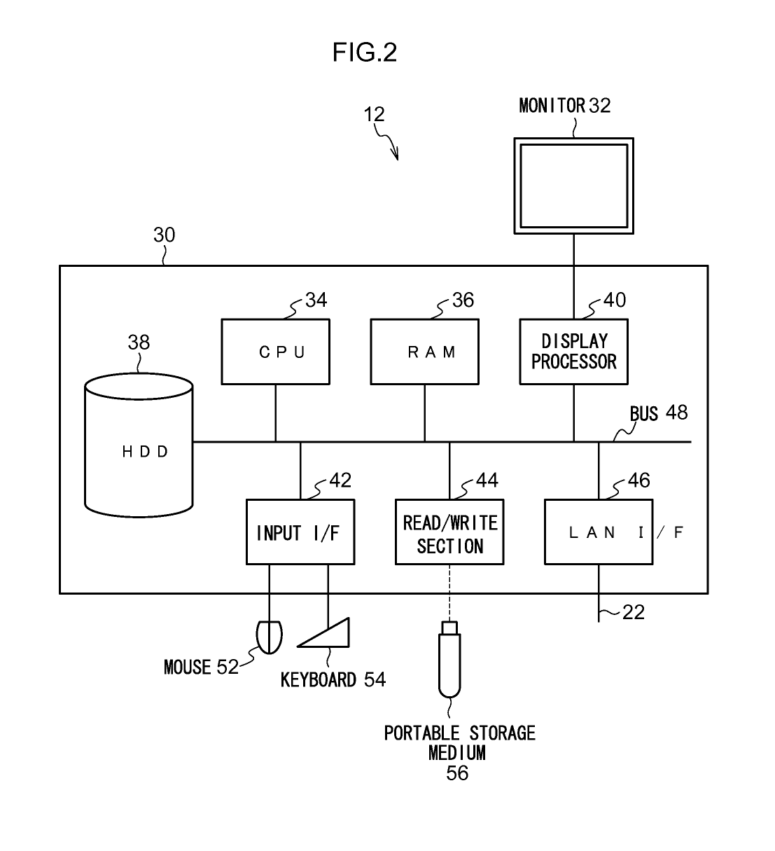

FIG. 2 is a block diagram of the management server 12. As illustrated in FIG. 2, the management server 12 includes a computer 30 that functions as the management server 12 main unit, and a monitor 32, a mouse 52, and a keyboard 54 that are connected to the computer 30. The computer 30 includes a Central Processing Unit (CPU) 34, Random Access Memory (RAM) 36, and a Hard Disk Drive (HDD) 38. The computer 30 includes a display processor 40 to which the monitor 32 is connected, and an input-output interface (UF) 42 to which the mouse 52 and the keyboard 54 are connected. The computer 30 includes a read/write section 44 that writes data to a portable storage medium 56, and reads data from the portable storage medium 56. The computer 30 also includes a Local Area Network (LAN) I/F 46 connected to the network 22.

A liquid crystal display (LCD), a cathode ray tube (CRT), or an organic electroluminescence display (OELD) may be applied as the monitor 32. A plasma display panel (PDP), a field effect display (FED) or the like may also be applied as the monitor 32.

A Solid State Drive (SSD), Digital Versatile Disk (DVD), an integrated circuit card (IC card), a magneto-optical disk, a CD-ROM (Compact Disk Read Only Memory) may be employed as the portable storage medium 56.

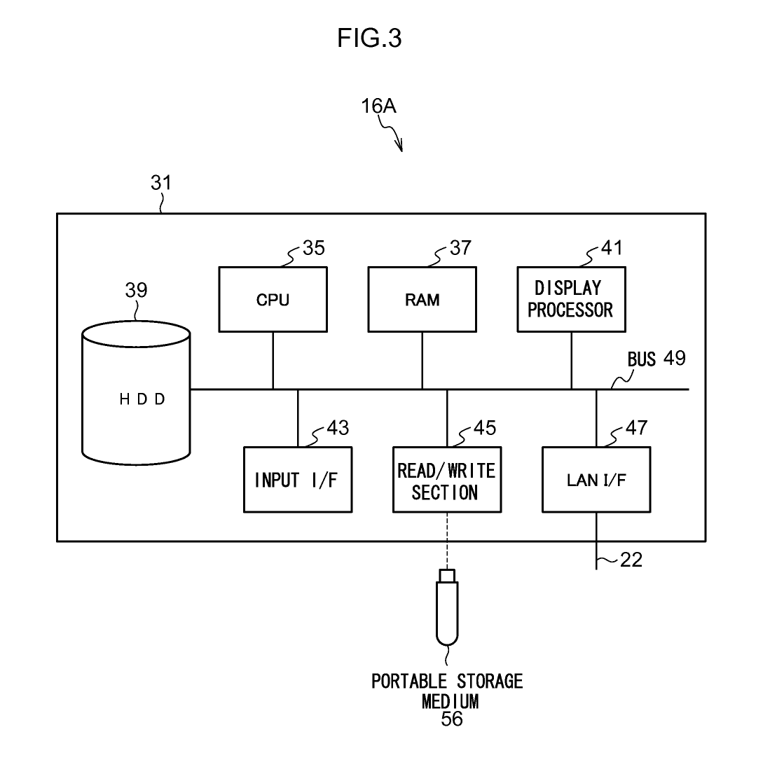

FIG. 3 illustrates a block diagram of the managed server 16A. Since the configuration of each of the managed servers is similar, explanation follows regarding the managed server 16A. As illustrated in FIG. 3, the managed server 16A includes a computer 31 that functions as the management server 16A main unit. The computer 31, similarly to the computer 30 that functions as the management server 12 main unit, includes a CPU 35, RAM 37, an HDD 39, a display processor 41, an input I/F 43, a read/write section 45, a LAN I/F 47, and a portable storage medium 56. The managed server 16A may also, similarly to the management server 12, include a monitor, mouse, and keyboard.

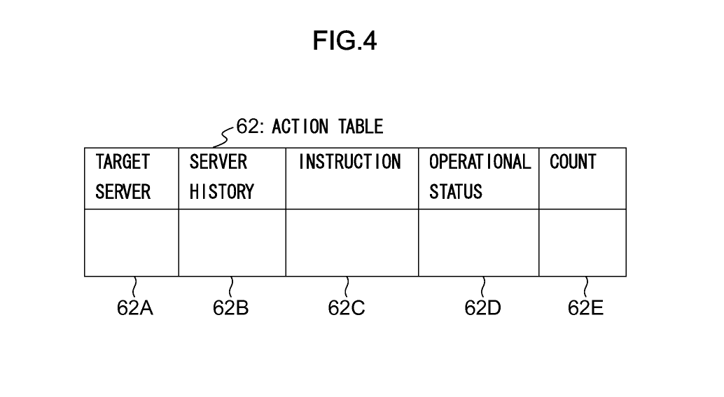

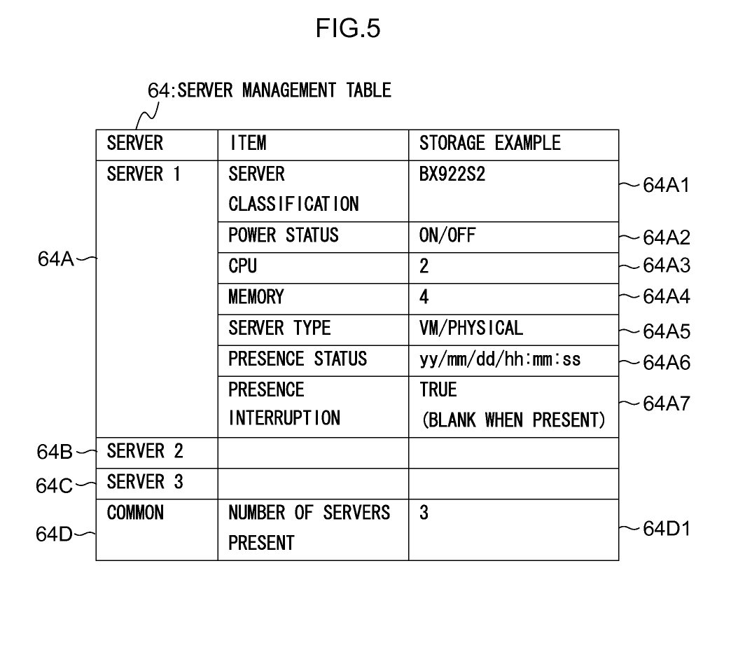

The common DBs 14A, 14B, etc. provided to each of the groups A, B, etc., each have similar configuration to each other, and so explanation follows regarding the common DB 14A, and explanation regarding the common DB 14B, etc. will be omitted. The common DB 14A includes regions 14A1, 14A2 (see FIG. 1) for storing data of each index and data corresponding to each index in the following action table 62 (see FIG. 4) and server management table 64 (see FIG. 5). The management server 12 and the managed servers 16A, 18A, 20A read from the common DB 14A data of each index and data corresponding to each index, expand the data in the RAM 36, 37, and generate the action table 62 and the server management table 64.

Namely, data written to each column corresponding to each of the indices provided in each of the tables expanded in the RAM 36 is stored as data of each of the indices and as data corresponding to each index in each of the regions 14A1, 14A2 of the common DB 14A. For ease of explanation, explanation follows of a case in which each of the data stored in the common DB 14A is the action table 62, or the server management table 64 generated in the RAM 36.

FIG. 4 illustrates the action table 62. As illustrated in FIG. 4, in the action table 62 a “target server”, a “server history”, an “instruction”, an “operational status”, and a “count” are defined as indices. In the action table 62, a target server column 62A is provided corresponding to the index “target server”. The target server column 62A is stored with identification data to identify the managed server designated when designating a managed server to execute designated processing, as described below. The identification data is data capable of uniquely identifying a managed server, and may, for example, employ an Internet Protocol (IP) address (for example 192.168.0.1), or may employ a server name or the like. In the present exemplary embodiment, the server name is employed as the identification data of the managed servers, with “server 1”, “server 2”, and “server 3” as the server names of each of the managed servers 16A, 18A, 20A.

A server history column 62B corresponding to the index “server history” is provided in the action table 62. Details are given below, however, briefly, identification data of managed servers that have already acquired, or taken over, processing are stored in the server history column 62B so that designated processing is not re-executed on the same managed servers.

An instruction column 62C corresponding to the index “instruction” is provided in the action table 62. Operation instruction data to instruct managed servers to execute processing is stored in the instruction column 62C. The processing indicated by the operation instruction data is, for example, switching power ON or OFF, creating or moving a virtual machine (VM), adding a managed server or the like.

An operational status column 62D is also provided in the action table 62, corresponding to the index “operational status”. Operation data indicating the operational status of the managed servers is stored in the operational status column 62D. In the present exemplary embodiment “not yet executed”, indicating that processing has not yet been started, “executing”, indicating processing is being executed, “complete” indicating that execution of processing has been completed, “abnormal end” or “execution not possible” indicating that processing has ended abnormally, are written as operation data.

A count column 62E corresponding to index “count” is provided to the action table 62. The number of managed server that have executed the designated processing is stored in the count column 62E.

FIG. 5 illustrates the server management table 64. As illustrated in FIG. 5, storage regions 64A, 64B, 64C defined to correspond to the managed servers 16A, 18A, 20A are provided in the server management table 64. A storage region 64D common to the managed servers 16A, 18A, 20A is also provided in the server management table 64. Since each of the storage regions 64A, 64B, 64C are each similar to each other, explanation follows regarding the storage region 64A, and the explanation regarding the other storage regions 64B, 64C will be omitted.

“Server classification”, “power status”, “CPU”, “memory”, “server type”, “presence status”, and “presence interruption” are defined as indices (items) in the storage region 64A.

A server classification column 64A1 corresponding to the index “server classification” is provided in the storage region 64A. A model number of the managed server 16A, for example, BX922S2, is stored in the server classification column 64A1.

A power status column 64A2 corresponding to the index “power status” is provided in the storage region 64A. The power status of the managed server 16A, for example, ON/OFF, is stored in the power status column 64A2.

A CPU column 64A3 corresponding to index “CPU” is provided in the storage region 64A. The frequency of the CPU, the number of cores of the CPU, and the like is stored in the CPU column 64A3.

A memory column 64A4 corresponding to the index “memory” is provided in the storage region 64A. The memory capacity is stored in the memory column 64A4.

A server type column 64A5 corresponding to the index “server type” is provided in the storage region 64A. Data indicating whether the managed server 16A is a VM or a physical server, for example VM/physical, is stored in the server type column 64A5.

A presence status column 64A6 corresponding to the index “presence status” is provided in the storage region 64A. Presence data to verify the presence of a managed server 16A is stored in the presence status column 64A6. The time (communication time) when the managed server 16A accessed the common DB 14A, for example, year/month/day/hour:minute:second (yy/mm/dd/hh:mm:ss) is employed as an example of presence data in the present exemplary embodiment. A simply 1, 0 flag may also be employed.

A presence interruption column 64A7 corresponding to the index “presence interruption” is provided in the storage region 64A. Data is stored in the presence interruption column 64A7 indicating whether or not the managed server 16A has interrupted presence. For example, when the managed server 16A has interrupted presence, true is stored to indicate that presence is interrupted. Nothing is stored (blank column) when the managed server 16A is present. The management server 12 is able to determine whether or not the managed server 16A is present (is operating) from the contents of the presence interruption column 64A7.

A number of servers present column 64D1 corresponding to the index “number of servers present” is provided in the storage region 64D. The number of managed server in operation (present) in the corresponding group is stored in the number of servers present column 64D1. In an initial state, the total number of managed servers in the corresponding group (three in the example above) is stored in the number of servers present column 64D1. After the initial state if, for example, the presence of one managed server is interrupted, the number stored in the number of servers present column 64D1 is decreased by one. Moreover, if a non-present managed server recovers, then the number stored in the number of servers present column 64D1 is increased by one. When the managed server is added to the group, the number stored in the number of servers present column 64D1 is also increased by one.

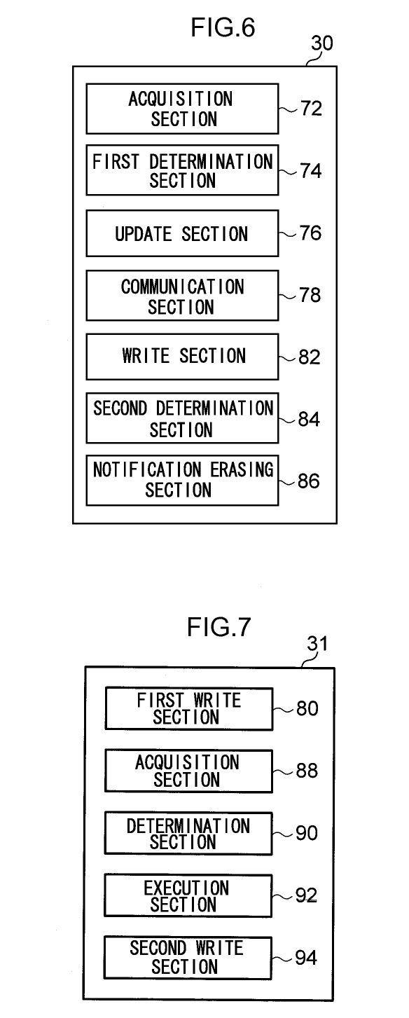

As illustrated in FIG. 6, the computer 30 functioning as the management server 12 main unit functionally includes an acquisition section 72, a first determination section 74, an update section 76, a communication section 78, a write section 82, a second determination section 84, and a notification erasing section 86. The acquisition section 72, the first determination section 74, the update section 76, and the communication section 78 are functional sections that function when presence verification processing, described below, is executed. The write section 82, the second determination section 84, and the notification erasing section 86 are functional sections that function when operation instruction processing, described below, is executed.

The computer 31 functioning as the managed server 16A main unit includes functionally, as illustrated in FIG. 7, a first write section 80, an acquisition section 88, a determination section 90, an execution section 92, and a second write section 94. The first write section 80 is a functional section that functions when presence data write processing, described below, is executed. The acquisition section 88, the determination section 90, the execution section 92, and the second write section 94 are functional sections that function when instruction execution processing, described below, is executed.

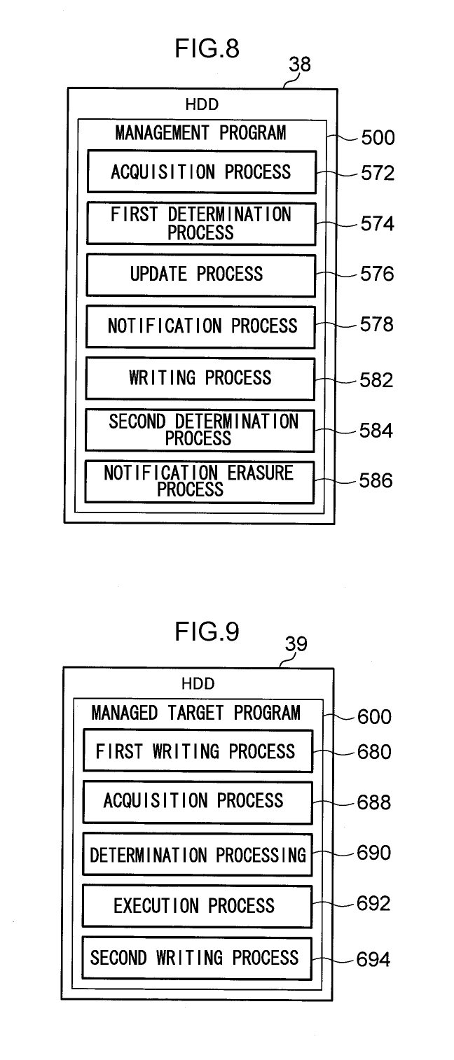

As illustrated in FIG. 8, a management program 500 for executing presence verification processing and operation instruction processing, described below, is stored in the HDD 38 of the management server 12. The CPU 34 of the management server 12 reads the management program 500 from the HDD 38, expands the management program 500 in the RAM 36, and sequentially executes the processes of the management program 500.

The management program 500 includes an acquisition process 572, a first determination process 574, an update process 576, a notification process 578, a write process 582, a second determination process 584, and a notification erasure process 586. The CPU 34 operates as the acquisition section 72 illustrated in FIG. 6 by executing the acquisition process 572. The CPU 34 operates as the first determination section 74 illustrated in FIG. 6 by executing the first determination process 574. The CPU 34 operates as the update section 76 illustrated in FIG. 6 by executing the update process 576. The CPU 34 operates as the communication section 78 illustrated in FIG. 6 by executing the notification process 578. The CPU 34 operates as the write section 82 illustrated in FIG. 6 by executing the write process 582. The CPU 34 operates as the second determination section 84 illustrated in FIG. 6 by executing the second determination process 584. The CPU 34 operates as the notification erasing section 86 illustrated in FIG. 6 by executing the notification erasure process 586.

As illustrated in FIG. 9, a managed target program 600 for executing presence data write processing and instruction execution processing, described below, is stored in the HDD 39 of the managed server 16A. The CPU 35 of the managed server 16A reads the managed target program 600 from the HDD 39, expands the managed target program 600 into the RAM 37, and sequentially executes the processes of the managed target program 600.

The managed target program 600 includes a first writing process 680, an acquisition process 688, a determination processing 690, an execution process 692, and a second writing process 694. The CPU 35 operates as the first write section 80 illustrated in FIG. 7 by executing the first writing process 680. The CPU 35 operates as the acquisition section 88 illustrated in FIG. 7 by executing the acquisition process 688. The CPU 35 operates as the determination section 90 illustrated in FIG. 7 by executing the determination processing 690. The CPU 35 operates as the execution section 92 illustrated in FIG. 7 by executing the execution process 692. The CPU 35 operates as the second write section 94 illustrated in FIG. 7 by executing the second writing process 694.

An example is given above in which each of the programs is read respectively from the HDDs 38 and 39, however the programs do not need always be stored on the HDDs 38 and 39 initially. For example, each of the corresponding programs may be stored on the portable storage medium 56 employed connected to the management server 12 and the managed server 16A. The management server 12 and the managed server 16A may then acquire each of the corresponding programs from the portable storage medium 56, and then execute the programs. Moreover, the programs may be stored on a storage section such as on another computer or server device connected to the management server 12 and the managed server 16A through a communication line. In such cases, the management server 12 and the managed server 16A acquire the corresponding program from the other computer or server device, and execute the program.

The managed server 18A and the managed server 20A also have similar functional sections to the functional sections in the managed server 16A (FIG. 7). The managed target program 600 is also stored on the HDDs 39 of the managed server 18A and the managed server 20A. The storage location and reading method for the managed target program 600 of the managed server 18A and the managed server 20A are similar to that of the managed server 16A.

Explanation next follows regarding operation of the exemplary embodiment. When the management server 12 is started up, presence verification processing to verify the presence of managed servers is executed in the management server 12. When processing to be executed on the managed server is input by an administrator, such as through the mouse 52 or the keyboard 54, operation instruction processing is executed on the management server 12 to instruct execution of processing on the managed server. When the managed server 16A is started up, the presence data write processing and the instruction execution processing are executed on the managed server 16A. Explanation mainly follows regarding the processing of the management server 12 and the managed server 16A of the group A. Similar applies to the managed server 18A and the managed server 20A of the same group A, and each of the managed servers of the other groups B etc., and so explanation thereof is omitted. Detailed explanation follows regarding each processing.

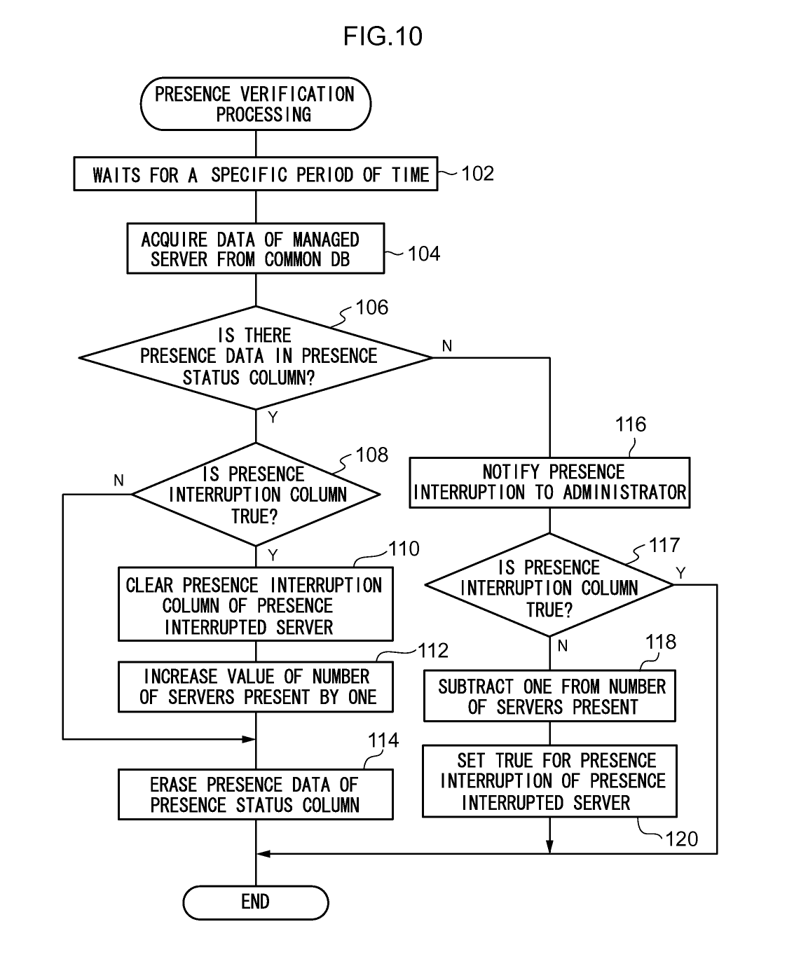

Explanation first follows regarding presence verification processing. FIG. 10 is a flowchart illustrating an example of presence verification processing of the managed server 16A repeatedly executed by the management server 12.

At step 102, the first determination section 74 waits for a specific period of time from start of the current processing.

At step 104, the acquisition section 72 acquires data of the server management table 64 from the common DB 14A, and acquires each of the indices and data corresponding the indices from the storage region 64A corresponding to the managed server 16A.

Explanation follows regarding processing to verify the presence of the managed server 16A, however the management server 12 also verifies the presence of the other managed servers 18A, 20A. In the processing of step 104 performed when the management server 12 is verifying the presence of the other managed servers 18A, 20A, since the data of the server management table 64 has already been acquired, there is no new acquisition of the data of the server management table 64. In the processing of step 104 performed when the management server 12 is verifying the presence of the other managed servers 18A, 20A, the data corresponding to the other managed servers 18A, 20A is acquired from the data of the already acquired server management table 64.

At step 106, the first determination section 74 determines whether or not the presence data (in this case the communication time) is stored in the presence state column 64A6.

Explanation next follows regarding the technical meaning of the processing of step 106.

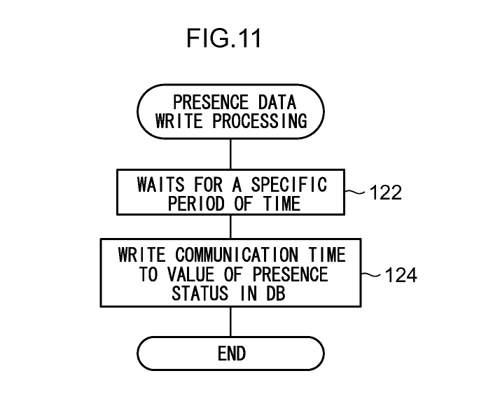

First, the managed server 16A repeatedly executes the presence data write processing illustrated as an example in FIG. 11. At step 122 of FIG. 11, the first write section 80 waits for a specific period of time from after the start of presence data write processing. At the next step 124, the first write section 80 writs the communication time (current time) to the presence state column 64A6 corresponding to the managed server 16A in the server management table 64 stored in the common DB 14A.

The presence data written to the presence status column 64A6 at step 124 is erased by the management server 12 as described below (step 114 of FIG. 10). The managed server 16A repeatedly executes the presence data write processing, and so at step 122 the first write section 80 of the managed server 16A waits a specific period of time, and then writes to the presence status column 64A6 presence data of the communication time when it re-accessed the common DB 14A. The management server 12 also repeatedly executes the presence verification processing, and so the management server 12 erases the presence data written to the presence status column 64A6. Thus a new communication time is written to the presence status column 64A6 as presence data if the managed server 16A is present at fixed intervals of time. If, however, the power to the managed server 16A is interrupted, or a malfunction occurs in the managed server 16A, causing the managed server 16A to no longer be present, then it is no longer possible to access the common DB 14A from the managed server 16A. Consequently, new presence data is not written by the managed server 16A to the presence status column 64A6. Thus determination is that the managed server 16A is no longer present when presence data has not been written to the presence status column 64A6. Determination is that the managed server 16A is present when presence data is being written to the presence status column 64A6.

The management server 12 thereby determines the presence of the managed server 16A based on the presence data written to the presence status column 64A6. The managed server 16A, writes presence data to the presence status column 64A6 at a specific timing by waiting a specific period of time at step 122. This specific timing may be a fixed interval timing predetermined based on the execution frequency of presence verification by the management server 12 for each of the managed servers. The management server 12 verifies the presence status column 64A6 at a timing according to the timing the presence data was written by the managed server 16A. A fixed timing predetermined according to the timing the presence data is written by each of the managed server may be set as the corresponding timing. The specific waiting time of the management server 12 at step 102 is set to an appropriate value so as to perform verification of the presence status column 64A6 at the corresponding timing.

As described above, at step 106, the first determination section 74 of the management server 12 determines whether or not the managed server 16A is present.

Determination is that the managed server 16A is present if the determination result of step 106 is affirmative determination, and at step 108, the first determination section 74 determines whether or not true has been written to the presence interruption column 64A7. Detailed explanation is given below, however briefly, the first determination section 74 determines whether or not the managed server 16A whose presence has been interrupted has recovered by whether or not true is written to the presence interruption column 64A7.

If the determination result of step 108 is negative determination, the managed server 16A is able to determine that the managed server 16A continues to be present, rather than has recovered. The presence verification processing skips to step 114 when the determination result of step 108 is negative determination. At step 114, the update section 76 erases the presence data of the presence status column 64A6 so as to be able determine whether or not the managed server 16A is present at step 106. Thus sometimes there is no data corresponding to the presence status index stored in the common DB 14A.

Accordingly, if the managed server 16A is present, alternately the presence data is written to the presence status column 64A6 by the managed server 16A, then the presence data written to the presence status column 64A6 is erased by the management server 12, in a continuous manner.

However, if the managed server 16A is not present, then the determination result of step 106 is negative determination since the presence data is not being written to the presence status column 64A6. If the determination result of step 106 is negative determination, the presence verification processing proceeds to step 116. At step 116, the communication section 78 notifies the administrator that presence has been interrupted. More specifically, the communication section 78 controls the display processor 40 to display the fact that the managed server 16A is not present on the monitor 32.

At step 117, the first determination section 74 determines whether or not true has been written to the presence interruption column 64A7. When the determination result of step 117 is negative determination, this is a case in which the managed server 16A present when presence verification processing was executed the previous time, is determined not to be present when presence verification processing is executed the current time. When the determination result of step 117 is negative determination, at step 118, the update section 76 subtracts one from the value of number of servers present column 64D1 in the server management table 64. At the next step 120, the update section 76 stores true in the presence interruption column 64A7. When the determination result of step 117 is affirmative determination, this is a case in which it was already determined that the managed server 16A was not present by the presence verification processing executed the previous time. Steps 118, 120 are skipped when the determination result of step 117 is affirmative determination, and the presence verification processing is ended.

As explained above, during the presence of the managed server 16A, then the determination result of step 106 is affirmative determination, and the determination result of step 108 is negative determination.

However, during the absence of the managed server 16A, the determination result of step 106 is negative determination. However, if presence of the managed server 16A recovers, then the presence data write processing of FIG. 11 is executed by the recovered managed server 16A, presence data is written to the presence status column 64A6, and the determination result of step 106 becomes affirmative determination. However, the determination result of the next step 108 is affirmative determination. This is because the presence interruption column 64A7 has continued storing true from when the presence of the managed server 16A was lost. Thus in the above manner, when the managed server 16A has recovered after an interruption in presence, the determination result at step 106 becomes affirmative determination, and the determination result at step 108 also becomes affirmative determination.

When the determination result of step 108 is affirmative determination, since this means that the managed server 16A has recovered, the update section 76 clears the presence interruption column 64A7 at step 110, and at step 112 the update section 76 increases the value of number of servers present column 64D1 by one. The processing of step 110 may be executed after the processing of step 112.

Advantageous Effect in Mode Identifying the State of the Managed Server 16A

As explained above, in the present exemplary embodiment, the management server 12 is able to verify whether or not the managed servers 16A to 20A are present by referencing the presence interruption column in the common DB 14A corresponding to each of the managed servers 16A to 20A. The management server 12 is thereby able to verify whether or not the managed servers 16A to 20A are present even without communicating with each of the managed servers 16A to 20A, enabling the load on the management server 12 to be reduced. Moreover, due to the management server 12 not communicating with each of the managed servers 16A to 20A, the volume of communication by the managed servers 16A to 20A is also reduced. Moreover, even if an abnormality arises in one or other of the managed servers 16A to 20A, accurate presence verification can still be performed for each of the managed server since the abnormality does not affect the presence verification of the other managed servers.

Modified Example of Mode Identifying the State of the Managed Server 16A

In the exemplary embodiment explained above, the managed server 16A writes the communication time as presence data to the presence status column 64A6 provided corresponding to the managed server 16A at a specific timing. The management server 12 verifies the written communication time at a timing according to the specific timing. After verification, the management server 12 then erases the communication time. The present exemplary embodiment is, however, not limited to such a mode, and the following modified example is possible.

### First Modified Example

In a first modified example, after the communication time has been erased in the presence status column 64A6 at the specific timing, the managed server 16A then writes a new communication time to the presence status column 64A6. The management server 12 acquires the written communication time at a timing according to the specific timing, and compares the acquired communication time with the communication time acquired the previous time. This thereby enables determination that the managed server is present when the written communication time has changed from that of the previous time. Thus the first modified example is also able to verify the presence status of the managed server 16A, similarly to in the above exemplary embodiment.

### Second Modified Example

In the second modified example, the management server 12 writes a new communication time to the presence status column 64A6 at a specific timing. The managed server 16A erases the written communication time at a timing according to the specific timing. The management server 12 is thereby able to determine the presence of the managed server 16A when, during writing the new communication time, the previously written communication time is found to have been erased. The second modified example is thereby also able to verify the presence status of the managed server 16A, similarly to in the above exemplary embodiment.

### Third Modified Example

In the above exemplary embodiment, the communication time is stored in the pre-provided presence status column 64A6 corresponding to the managed server 16A. However, in a third modified example, the managed server 16A associates data of the communication time with identification data of the managed server 16A, and stores these in an arbitrary region of the common DB 14A. The management server 12 then, at a timing according to the specific timing when the managed server 16A newly stored the identification data and the communication time, searches for a stored communication time using the identification data of the managed server 16A, and determines whether or not a communication time has been newly stored. The third modified example is also able to verify the presence status of the managed server 16A similarly to in the above exemplary embodiment.

### Fourth Modified Example

In a fourth modified example, in place of writing a communication time to the presence status column 64A6, or as well as writing a communication time to the presence status column 64A6, the managed server 16A writes the operational status of the managed server 16A. The management server 12 is thereby able to verify the operational status of the managed server 16A.

Explanation has been given in the above exemplary embodiment and modified examples of cases in which the communication time is written to the presence status column 64A6 as the presence status, however there is no limitation thereto. A number, symbol, or other flag indicating presence may be written. Moreover, for example, by writing presence data that differs from the previously written presence data, such as increasing a number by one each time it is written to the presence status column 64A6, similarly to in the first modified example, the presence of the managed server 16A can be determined from change to the written presence data.

Operation Instructions to the Managed Servers

Explanation follows regarding operation instruction processing by which the management server 12 instructs the managed servers 16A to 20A to perform processing, and instruction execution processing in which the managed servers 16A to 20A execute the instructed processing.

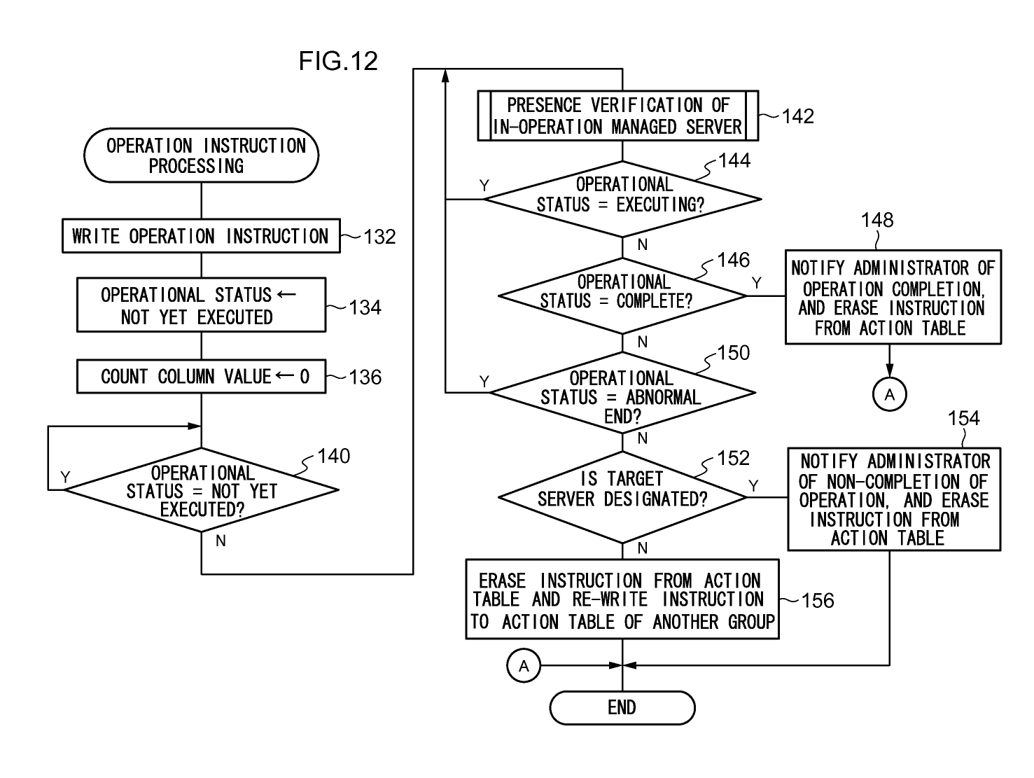

FIG. 12 is a flowchart illustrating an example of operation instruction processing of the management server 12 to the managed servers 16A to 20A.

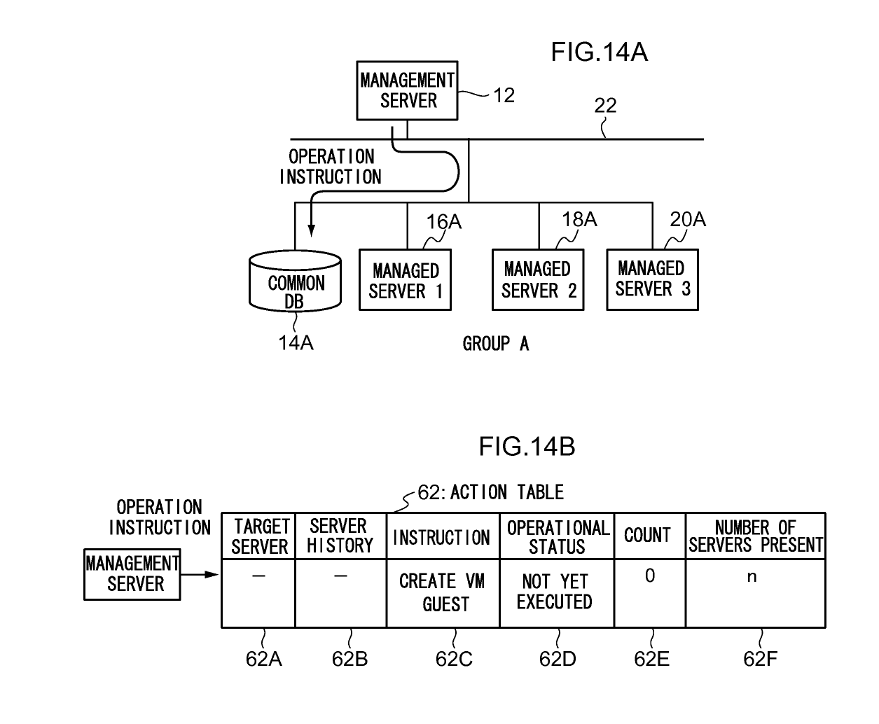

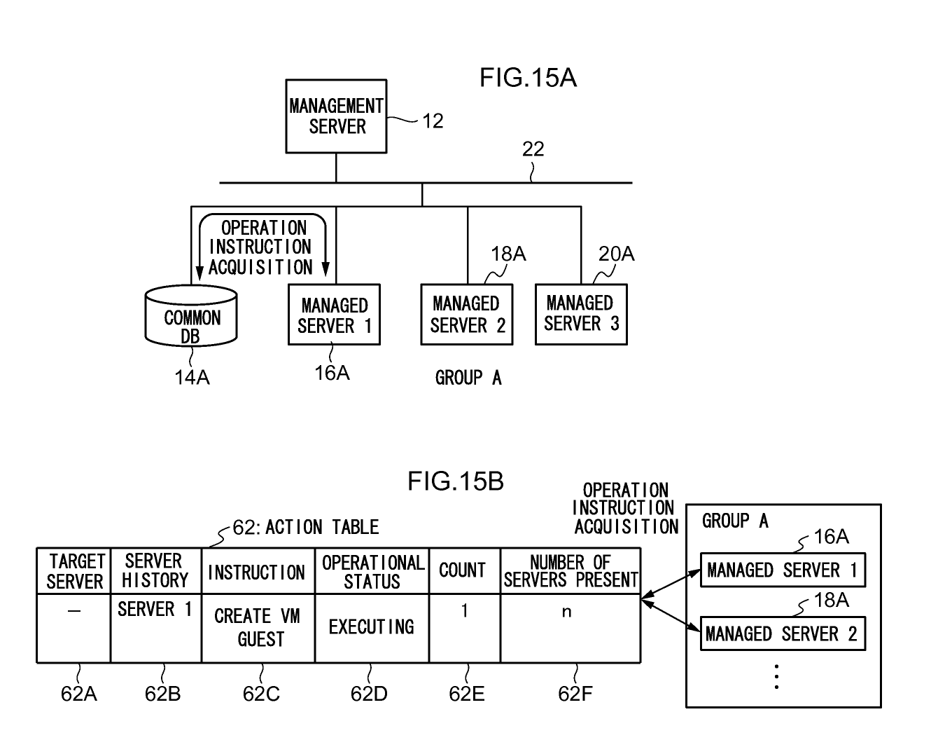

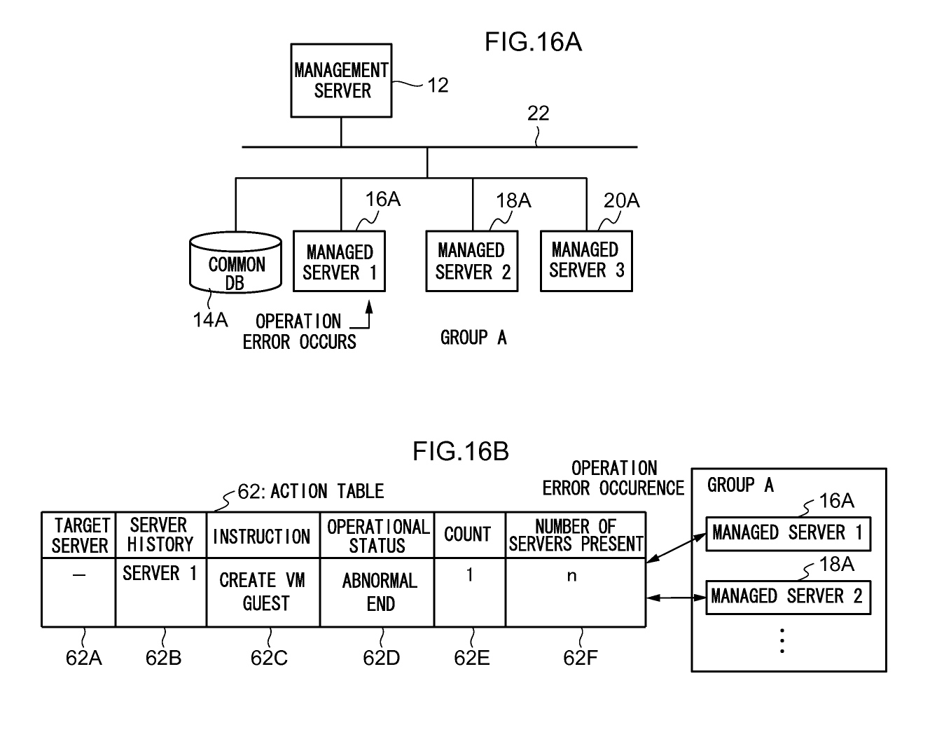

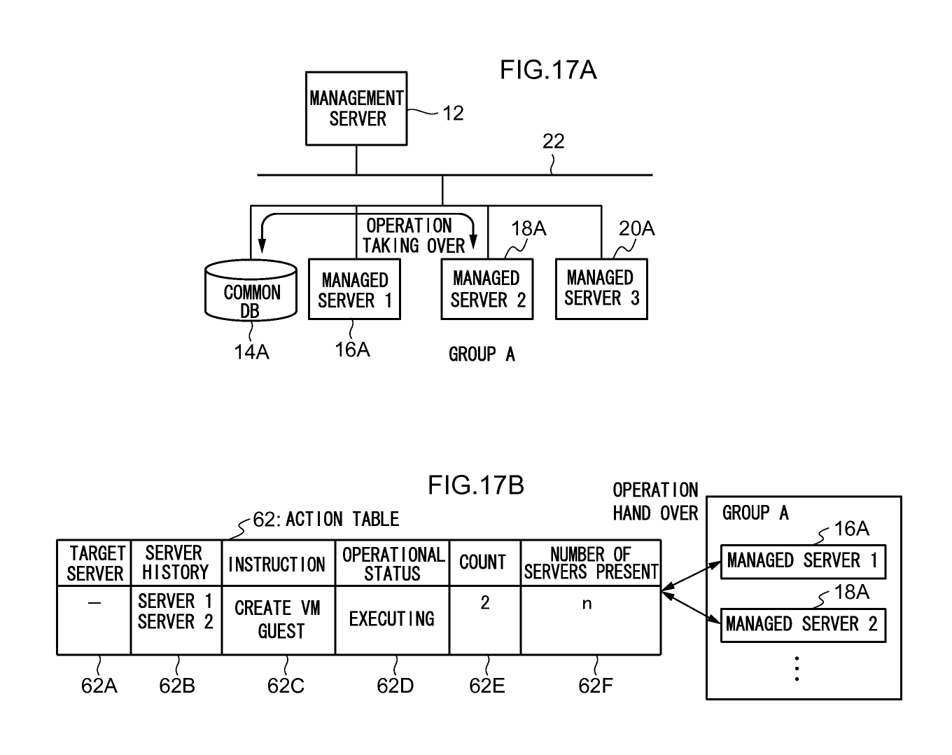

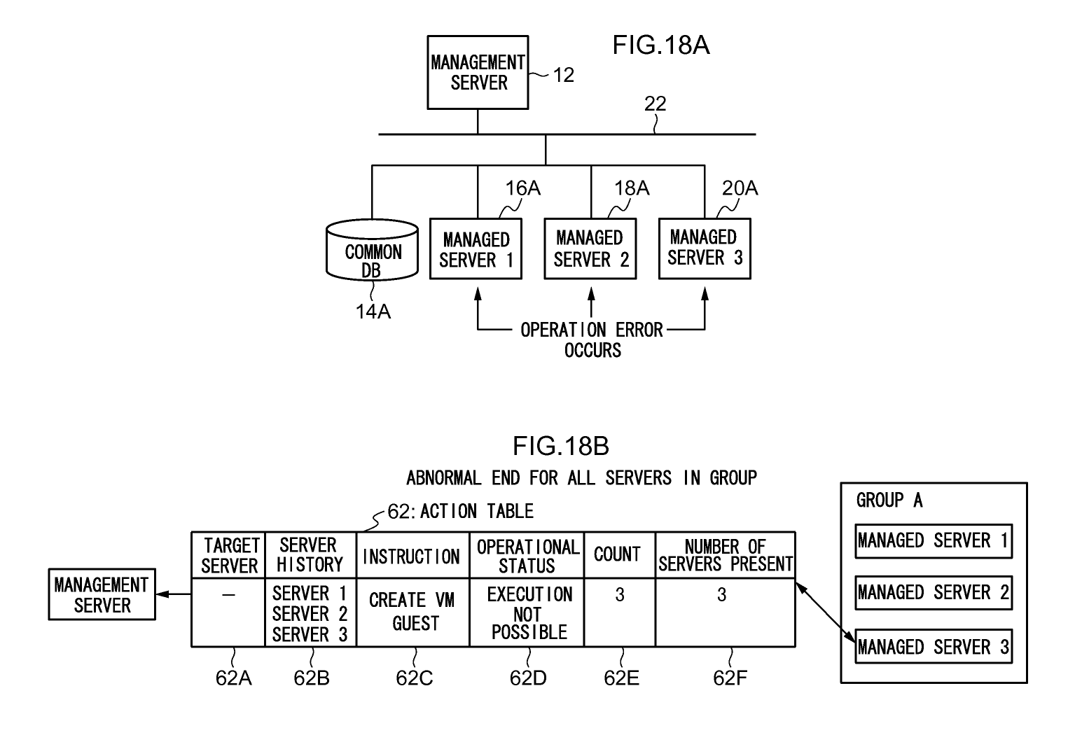

FIG. 14A illustrates operation instruction from the management server 12 to the common DB 14A, and FIG. 14B illustrates an action table 62 written with data for when the management server 12 instructs operation. For ease of explanation, in FIG. 14B, the number of servers present stored in the number of servers present column 64D1 of the server management table 64 is also listed in combination with the action table 62 (62F in FIG. 14B). Similar applies to FIG. 15B, FIG. 16B, FIG. 17B, and FIG. 18B.

The management server 12 does not directly instruction operation to the managed servers 16A to 20A of group A, and instead, as illustrated in FIG. 14A, writes operation instruction data to the common DB 14A. More specifically, at step 132 of FIG. 12, the write section 82 writes operation instruction data to the instruction column 62C in the write section 82, as illustrated in FIG. 14B. In FIG. 14B, an example is given of processing in which operation instruction data representing an instruction to create a VM guest has been written. The write section 82 does not write anything to the target server column 62A to execute the instructed processing without selecting one of the managed servers 16A to 20A belonging to the group A. However, to execute the instructed processing on one or plural of the managed servers selected from the managed servers 16A to 20A belonging to group A, the write section 82 writes the target server column 62A with identification data of the managed servers to execute the instructed processing.

Then at step 134, the write section 82 writes “not yet executed” to the operational status column 62D, as illustrated in FIG. 14B. At the next step 136, the write section 82 writes “0” to the count column 62E as illustrated in FIG. 14B.

Note that the sequence of the processing of steps 132 to 136 is not limited to that of the sequence numbers of steps 132 to 136, and execution may start from any step, continue from any step, and finish at any step.

At step 140, the second determination section 84 acquires data of the operational status column 62D of the action table 62 in the common DB 14A, and determines whether or not the operational status is “not yet executed”. The processing of step 140 is repeated until the determination result of step 140 is negative determination.

FIG. 15A illustrates the managed server 16A acquiring an operation instruction from the management server 12, and FIG. 15B illustrates an action table 62 written with data when the managed server 16A has acquired the operation instruction. Detailed explanation is given below, however briefly, when identification data of the managed server is written to the target server column 62A, the managed server indicated by the identification data acquires the operation instruction, from out of the managed servers 16A to 20A belonging to group A. When identification data of the managed server is not written to the target server column 62A, one of the managed servers acquires the operation instruction from out of the managed servers 16A to 20A belonging to the group A. For example, the first of the managed servers to access the common DB 14A after the operation instruction has been written to the common DB 14A acquires the operation instruction. Explanation follows regarding of a case in which the first managed server to make access is the managed server 16A. The managed server 16A that acquired the operation instruction then writes “executing” to the operational status column 62D, as illustrated in FIG. 15B.

The determination result of step 140 accordingly is negative determination when the managed server 16A has written “executing” to the operational status column 62D. When the determination result of step 140 is negative determination, at step 142 the management server 12 executes presence verification of the in-operation managed server 16A. The processing of step 142 is explained below. The “in-operation managed server” is the managed server that has acquired, or taken over, the operation instruction. Explanation is given below about taking over an operation instruction.

Determination at step 140 is by detecting a change from “not yet executed” to “executing” in the operational status written to the operational status column 62D. However, sometimes the management server 12 changes the operational status of the managed server that acquired the operation instruction changes from “executing” to “abnormal end”, “execution not possible”, or “complete” when the duration until determination at step 140 is too long since writing the operation instruction data to the instruction column 62C. In such cases, in order to avoid determination at step 140 being negative determination, the determination at step 140 is set so as to be executed at extremely small intervals.

At step 144, the data stored in the operational status column 62D of the action table 62 is acquired from the common DB 14A, and determination is made as to whether or not the operational status is “executing”. In this example, the operational status of the managed server 16A that acquired the operation instruction is “executing”. The determination result of step 144 is accordingly affirmative determination, the operation instruction processing returns to step 142, and the presence verification processing of the in-operation managed server 16A is executed.

When the determination result of step 144 is negative determination, at step 146, the second determination section 84 determines whether or not the operational status stored in the operational status column 62D acquired at step 144 is “complete”. When execution of the instructed processing has been completed, the managed server that completed the processing overwrites “executing” of the operational status column 62D in the action table 62 (see FIG. 15B) with “complete”. When the operational status of the operational status column 62D is “complete”, the determination result of step 146 is affirmative determination. When the determination result of step 146 is affirmative determination, at step 148 the notification erasing section 86 notifies the administrator that the instructed processing has been completed. More specifically, the notification erasing section 86 controls the display processor 40 to display on the monitor 32 that the instructed processing has been completed. Moreover, the notification erasing section 86 erases the operation instruction data from the instruction column 62C of the action table 62. Operation instruction processing is ended when the processing of step 148 has been executed.

When the determination result of step 146 is negative determination, at step 150, the second determination section 84 determines whether or not the operational status stored in the operational status column 62D acquired at step 144 is “abnormal end”.

FIG. 16A illustrates occurrence of an operation error in the managed server 16A, and FIG. 16B illustrates an action table 62 written when the operation error has occurred. Sometimes the instructed processing is not completed in the managed server 16A that acquired the operation instruction, and, as illustrated in FIG. 16A, an operation error occurs. For example, in the above example the instructed processing is create a VM, however sometimes it is not possible to create a new VM in the managed server 16A due to utilization of the CPU 34 and memory capacity of the HDD 38. When such an operation error occurs, in which it is not possible to complete execution of the processing instructed by the acquired operation instruction in the managed server 16A, the managed server 16A, as illustrated in FIG. 16B, stores “abnormal end” in the operational status column 62D of the action table 62. The determination result at step 150 is affirmative determination when “abnormal end” is stored in the operational status column 62D of the action table 62.

FIG. 17A illustrates the managed server 18A taking over the operation instruction from the management server 12, and FIG. 17B illustrates an action table 62 written with data when the managed server 18A takes over the operation instruction. When the determination result of step 150 is affirmative determination, the operation instruction processing returns to step 142. Detailed explanation is given below, however briefly, when an operation error has occurred in the managed server 16A that acquired the operation instruction (FIG. 16A), the managed server 18A, for example, takes over the operation instruction, as illustrated in FIG. 17A. The managed server 18A that has taken over the operation instruction stores “executing” in the operational status column 62D of the action table 62, as illustrated in FIG. 17B. Thereby, via step 142, the determination result of step 144 is affirmative determination. When execution of the instructed processing has been completed in the managed server 18A, the determination result of step 146 is affirmative determination, and the processing of step 148 is executed.

The managed server 20A takes over the operation instruction when an operation error has occurred in the managed server 18A. When the instructed processing has been completed in the managed server 20A, the determination result of step 146 is affirmative determination, and the processing of step 148 is executed.

FIG. 18A illustrates an example in which an operation error has occurred in all the managed servers 16A to 20A. FIG. 18B illustrates an action table 62 written with data when an operation error has occurred in all the managed servers 16A to 20A. As illustrated in FIG. 18A, sometimes an operation error occurs in all of the managed servers 16A to 20A belonging to the group A. Detailed explanation is given below, however briefly, sometimes the final managed server 20A, this being the one managed server remaining that has not taken over the operation instruction, takes over the operation instruction, but an operation error also occurs in the final managed server 20A. When an operation error occurs even in the final managed server 20A, the managed server 20A writes “execution not possible” to the operational status column 62D, as illustrated in FIG. 18B. The determination result of step 150 is negative determination when “execution not possible” is stored in the operational status column 62D.

However, detailed explanation is given below, however briefly, sometimes an operation error occurs in a managed server instructed to execute the processing indicated by the operation instruction. Even though an operation error occurs in a managed server instructed to execute the processing indicated by the operation instruction, another managed server is not able to take over the operation instruction. In such cases, the managed server instructed to execute the processing indicate by the operation instruction writes “execution not possible” to the operational status column 62D in the action table 62, irrespective of whether or not it is the final managed server in the group, and the determination result of step 150 is negative determination.

When the determination result of step 150 is negative determination, at step 152, the second determination section 84 determines whether or not a managed server is being designated based on whether or not identification data of a managed server is stored in the target server column 62A of the action table 62.

When the determination result of step 152 is affirmative determination, since taking over of the operation instruction is not expected, there is no managed server present capable of taking over the operation instruction. Here, at step 154, the notification erasing section 86 notifies the administrator of execution of non-completion of the instructed processing. More specifically, the notification erasing section 86 controls the display processor 40 to display non-completion of execution of the instructed processing on the monitor 32. The notification erasing section 86 also erases the operation instruction data from the instruction column 62C of the action table 62. The operation instruction processing is ended when the processing of step 154 has been executed.

When the determination result of step 152 is negative determination, taking over of the operation instruction is expected. Moreover, sometimes transition of the operation instruction processing to step 152 is for a case in which the managed server to take over the operation instruction is not present in the group A.

As illustrated in FIG. 1, the server management system 10 in the present exemplary embodiment is provided with a common DB corresponding to each of the groups. The following is the reason that the common DB is provided corresponding to each of the groups. When many managed server use a single common DB, then the overall processing time becomes longer. More precisely, when one of the managed servers is accessing a single DB, and the other many managed servers attempt to access the single DB, the other many managed servers are instructed to wait for a fixed period of time (mutual exclusion processing). So repetition of such mutual exclusion processing makes the overall processing time longer. Hence in the present exemplary embodiment, an appropriate number, for example, three of the managed servers, belong to a single group.

Thus, generally plural groups A, B, etc. are provided in order to prevent the overall processing time from becoming longer. Thus an operation instruction instructing a given group rather than instructing a managed server to execute processing is not an indication that it is expected that processing will only be performed by a managed server belonging to that group.

When the determination result of step 152 is negative determination, at step 156, the write section 82 first erases operation instruction data from the executing action table 62 stored on the common DB 14A. The write section 82 then writes operation instruction data to the instruction column 62C of the action table 62 stored in the common DB 14B of the other group B. The instruction execution processing is then executed by the managed servers 16B to 20B in the group B.

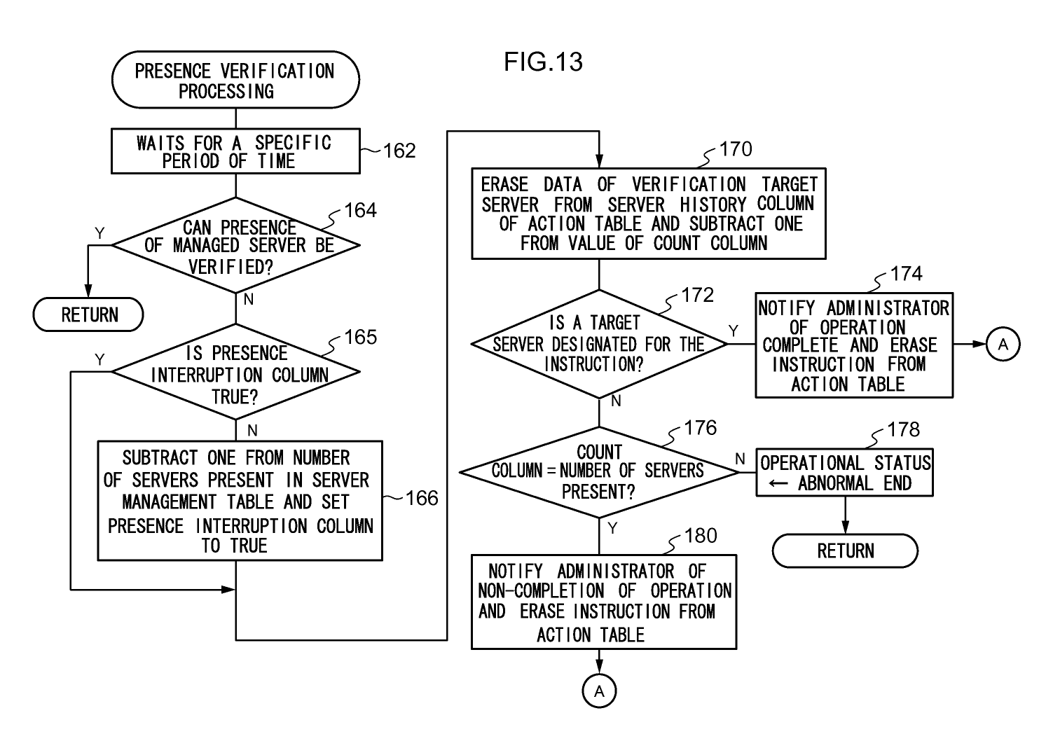

Explanation follows regarding presence verification processing at step 142 in FIG. 12. FIG. 13 is a flowchart illustrating an example of presence verification processing at step 142 of FIG. 12.

At step 162, the second determination section 84 waits for a specific period of time. The specific period of time is determined as a time interval to execute the presence verification processing of the managed server that are in operation, and is predetermined according to the processing time of the managed servers to operation instructions, the timing of the managed server writing presence data to the common DB, and the like.

Then, at step 164, the second determination section 84 identifies managed servers that are targets for presence verification (referred to below as “verification target managed servers”). More specifically, the second determination section 84 identifies verification target managed servers from the latest identification data of the managed server stored in the server history column 62B when the operational status column 62D of the action table 62 is “executing”. As described below, the history of the managed server that executed the processing is stored in the server history column 62B. For example, in the example of FIG. 15B, the managed server 16A is identified as the verification target managed server from the entry “sever 1” stored in the server history column 62B. The second determination section 84 determines whether or not the presence of the verification target managed server 16A can be verified. More specifically, the second determination section 84 determines whether or not the presence of the verification target managed server 16A can be verified by determining whether or not a communication time is stored in the common DB 14A corresponding to the presence status column 64A6 in the server management table 64.

Presence verification of each of the managed servers is also performed in the processing illustrated in FIG. 10. However, sometimes at the timing of the processing illustrated in FIG. 10 it is not possible to verify non-presence for managed servers that have already become absent. At step 164 the second determination section 84 verifies the presence of the verification target managed server.

When the determination result of step 164 is affirmative determination, the presence verification processing is ended, and operation instruction processing proceeds to step 144 (see FIG. 12). When the determination result of step 164 is negative determination, at step 165, the second determination section 84 determines whether or not the presence interruption column 64A7 is true.

When the determination result of step 165 is negative determination, this indicates that presence verification has not been obtained for the verification target managed server by the presence verification processing illustrated in FIG. 10. At step 166, the write section 82 subtracts one from the value stored in the number of servers present column 64D1 of the server management table 64. The write section 82 stores true in the presence interruption column 64A7.

When the determination result of step 165 is affirmative determination, this indicates that non-presence of the verification target managed server has been verified by the presence verification processing illustrated in FIG. 10, and processing similar to that of step 166 is executed (step 118 and step 120). In order to prevent duplication of the processing of step 166 when the determination result of step 165 is affirmative determination, step 166 is skipped, and the presence verification processing transitions to step 170.

At step 170, the write section 82 erases identification data of the verification target managed server 16A from the server history column 62B of the action table 62, and subtracts one from the value stored in the count column 62E.

Explanation follows regarding the reason for the processing of step 168 and step 170.

The managed server 16A writes “executing” to the operational status column 62D of the action table 62 (see FIG. 15B). Moreover, the managed server 16A writes identification data of the managed server 16A (server 1) to the server history column 62B, and increases the value of the count column 62E by one.

Consider a case in which the presence of the managed server 16A is interrupted after the managed server 16A has increased the value of the count column 62E by one.

In cases in which the presence of the managed server 16A has been interrupted, the value of the number of servers present column 64D1 of the server management table 64 (the value of a number of servers present column 62F listed for convenience in the action table 62) is reduced by one at step 118 or step 166. At this stage the value of the number of servers present column 64D1 is two. When the value of the count column 62E has been reduced by one when the presence of the managed server 16A is interrupted, all of the managed servers 16A to 20A in group A have ended abnormally, and the value of the count column 62E is three.

Determination as to whether or not all of the managed servers 16A to 20A of the group A have ended abnormally is, as described below, performed by determining whether or not the value of the count column 62E and the value of the number of servers present column 64D1 match each other.

Thus when the presence of the managed server 16A has been interrupted, unless the value of the count column 62E is reduced by one, the value of the count column 62E and the value of the number of servers present column 62F do not match each other. The management server 12 accordingly determines that a managed server is present other than the managed servers 16A to 20A. The presence verification processing accordingly continues.

The write section 82 reduces the value of the count column 62E by one when the presence of the managed server 16A has been interrupted.

At the next step 172, the second determination section 84 determines whether or not there is a managed server designated to execute the processing based on the target server column 62A of the action table 62. When the determination result of step 172 is affirmative determination, since the operation instruction is not expected to be taken over, there is no managed server present capable of taking over the operation instruction. At step 174, the notification erasing section 86 notifies the administrator that the instructed processing has not been completed. More specifically, the notification erasing section 86 controls the display processor 40 to display on the monitor 32 that the instructed processing has become non-complete. Moreover, the notification erasing section 86 erases the operation instruction data from the instruction column 62C of the action table 62. The presence verification processing and the operation instruction processing is ended when the processing of step 174 has been executed.

When the determination result of step 172 is negative determination, at step 176, the second determination section 84 determines whether or not the value of the count column 62E of the action table 62, and the number of servers present that is the number of servers present column 64D1 of the server management table 64, match each other.

The value in the count column 62E of the action table 62 is the number of managed servers that acquired, or took over, the operation instruction, and whose presence was not interrupted data during execution. The number of servers present, this being the number of servers present column 64D1, is the number of managed servers currently present in group A. Thus when the determination result of step 176 is affirmative determination, it can be determined that all of the managed servers present in group A which acquired, or took over, the operation instruction did not complete processing. In particular, it is possible to determine when the presence is interrupted of the final managed server to take over the operation instruction.

When the determination result of step 176 is affirmative determination, at step 180, the notification erasing section 86 notifies the administrator of non-completion of instructed processing. More specifically, the notification erasing section 86 controls the display processor 40 to display on the monitor 32 non-completion of the instructed processing. The notification erasing section 86 also erases the operation instruction data from the instruction column 62C in the action table 62. The presence verification processing and the operation instruction processing are ended when the processing of step 180 has been executed. When the determination result of step 176 is affirmative determination, in place of step 180, the operation instruction processing may progress to step 156.

When the determination result of step 176 is negative determination, at step 178, the write section 82 writes “abnormal end” to the operational status column 62D. The operation instruction is thereby taken over by the next managed server of the group A that accesses the common DB 14A.

Explanation next follows regarding instruction execution processing executed by the managed servers 16A to 20A belonging to group A. Since the instruction execution processing executed by each of the managed servers 16A to 20A is similar, explanation follows regarding embodiment is provided executed by the managed server 16A.

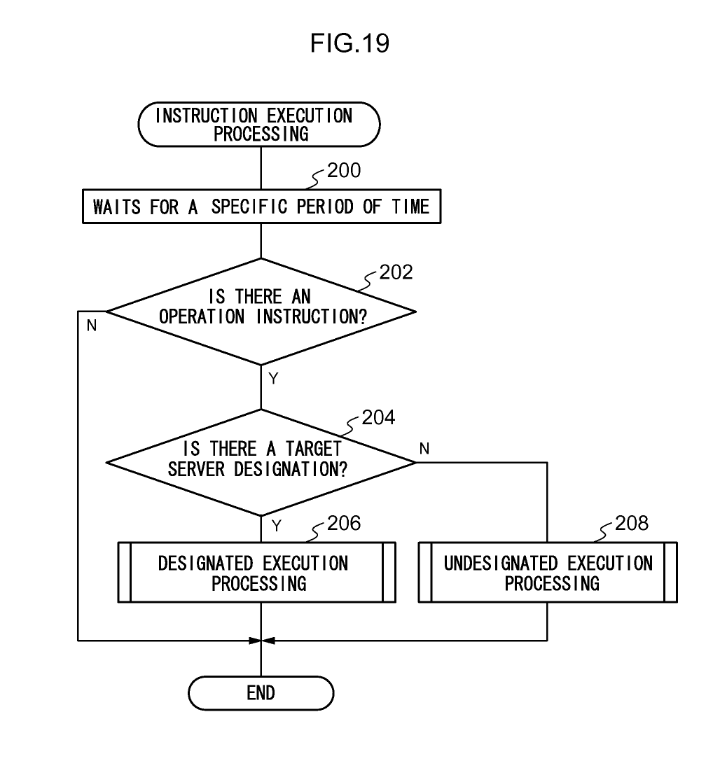

FIG. 19 is a flowchart illustrating an example of instruction execution processing repeatedly executed by the managed server 16A. At step 200 of FIG. 19, the determination section 90 waits for a specific period of time. Each of the managed server belonging to the group A access the common DB 14A at respective specific timings. In order to prevent double-access to the common DB 14A, the specific timing each of the managed servers access the common DB 14A are set so as to be respective different timings. The specific timing may be a timing repeating at a fixed interval. Thus the specific period of time of waiting in the current step is pre-set so as to allow the managed servers to access the common DB 14A at a specific timing.

Next, at step 202, the acquisition section 88 acquires data of the action table 62 from the common DB 14A, and creates the action table 62 from the acquired data in the RAM 36 of the managed server 16A. The determination section 90 verifies the operational status column 62D of the created action table 62, and determines whether or not an operation instruction has been written thereto. The instruction execution processing is ended when the determination result of step 202 is negative determination. When the determination result of step 202 is affirmative determination, at step 204, the determination section 90 determines whether or not the managed server to execute the processing has been designated based on the content of the target server column 62A.

When the determination result of step 204 is affirmative determination, at step 206 the designated execution processing is executed, and when the determination result of step 204 is negative determination, undesignated execution processing is executed at step 208.

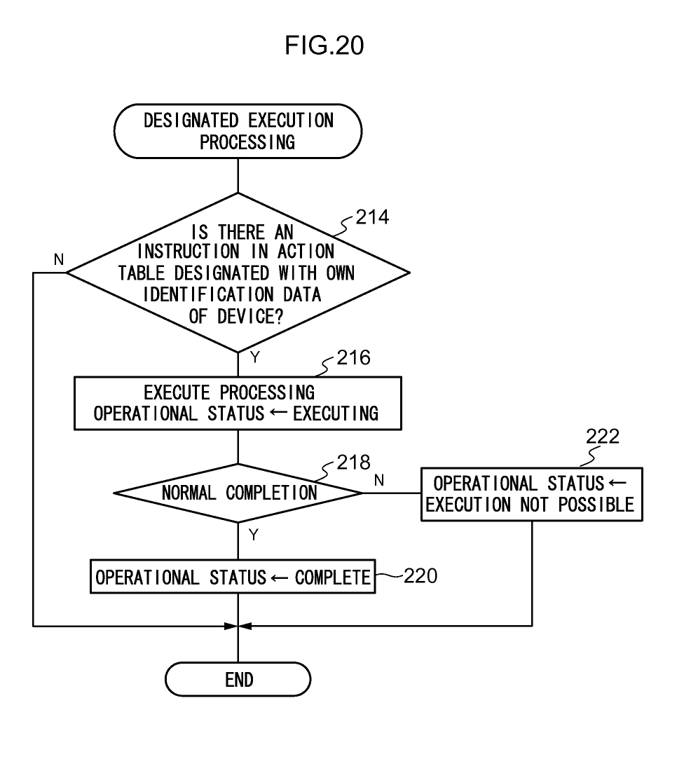

FIG. 20 illustrates a flowchart of the designated execution processing of step 206 of FIG. 19.

At step 214 of FIG. 20, the determination section 90 determines whether or not the processing is instructed to be executed in its own device by determining whether or not the identification data for its own device is stored in the target server column 62A of the action table 62. The designated execution processing and instruction execution processing is ended when the determination result of step 214 is negative determination.

When the determination result of step 214 is affirmative determination, since execution of the processing is designated for the managed server 16A of its own device, at step 216, the execution section 92 starts the processing indicated by the operation instruction data stored in the instruction column 62C, for example, creating a VM. When execution of the processing is started, the second write section 94 writes “executing” to the operational status column 62D of the action table 62. The data “executing” is thereby stored in the common DB 14A for the index “operational status”, and the determination result of step 144 of FIG. 12 becomes affirmative determination.

At step 218, the determination section 90 determines whether or not the instructed processing has normal completion. When the determination result of step 218 is negative determination, at step 222 the second write section 94 writes “execution not possible” to the operational status column 62D of the action table 62. The data of “execution not possible” is thereby stored in the common DB 14A for the index “operational status”, and the determination result of step 150 of FIG. 12 becomes affirmative determination, and the determination result of step 152 becomes affirmative determination.

When the determination result of step 218 is affirmative determination, at step 220, the second write section 94 writes “complete” to the operational status column 62D. Data “complete” is thereby stored in the common DB 14A for the index “operational status”, and the determination result of step 146 of FIG. 12 becomes affirmative determination.

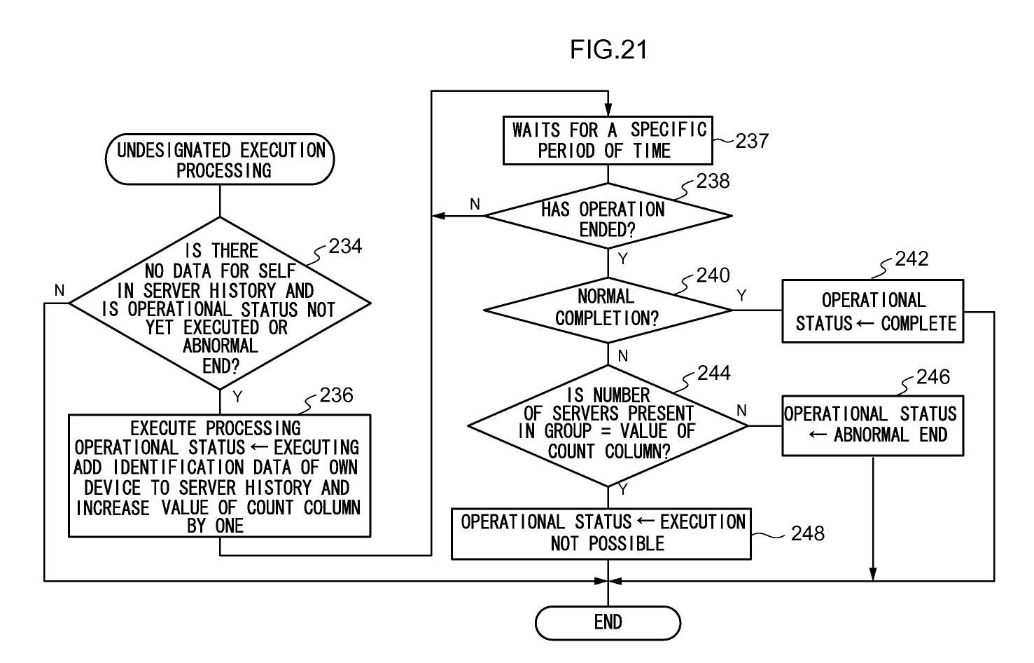

FIG. 21 illustrates a flowchart of undesignated execution processing of step 208 of FIG. 19.

At step 234 of FIG. 21, the determination section 90 determines whether or not the determination section 90 has not-written the identification data of its own device to the server history column 62B, and either “not yet executed” of “abnormal end” is written to the operational status column 62D.

Cases in which the identification data of its own device is written to the server history column 62B are sometimes cases in which take over proceeded as far as acquiring the operation instruction, however an operation error occurred, and so even if execution of the processing were to be started this time, a similar operation error might occur. Thus when the identification data of its own device is written to the server history column 62B, the determination result of step 234 is negative determination, and the undesignated execution processing and the instruction execution processing are ended.

When “executing” is written to the operational status column 62D, another managed server has acquired, or taken over, the operation instruction. There is a possibility that execution of the processing of the operation instruction completes in the other managed server, and so there is no need to execute the processing indicated by the operation instruction in its own device at the current stage. Thus the determination result of step 234 is negative determination, and the undesignated execution processing and the instruction execution processing are ended. Cases in which “execution not possible” is written to the operational status column 62D are sometimes cases in which processing could not be completed in all of the managed server present belonging to group A. The determination result of step 234 is accordingly negative determination, and the undesignated execution processing and the instruction execution processing are ended.

When the determination result of step 234 is affirmative determination, the device itself acquires, or takes over, the operation instruction, and at step 236, in first processing, the execution section 92 executes the processing indicated by the operation instruction data written to the instruction column 62C, for example processing to create a VM. In second processing, the second write section 94 writes “executing” to the operational status column 62D. Data of “executing” is thereby stored in the common DB 14A in the operational status column 62D, and the determination result of step 144 of FIG. 12 becomes affirmative determination.

In third processing, the second write section 94 adds identification data of the device itself to the server history column 62B. Identification data of other managed server already written to the server history column 62B is not erased. The determination of step 234 is employed in order to prevent re-execution by a managed server that ended abnormally.

In fourth processing, the second write section 94 increases the value of the count column 62E of the action table 62 by one. This is performed to save the number of managed server that have executed the processing, in order to be able to determine whether or not all of the managed servers present in group A have executed the processing.

The sequence of processing for the first to the fourth processing explained at step 236 is not limited to the sequence first to fourth, and processing may be performed in any sequence.

At step 237, the determination section 90 waits for a specific period of time. At the next step 238, the determination section 90 determines whether or not operation has ended. When the determination result of step 238 is negative determination, the undesignated execution processing returns to step 237. When the determination result of step 238 is affirmative determination, at step 240, the determination section 90 determines whether or not the processing has completed normally.

When the determination result of step 240 is affirmative determination, at step 242 the second write section 94 writes “complete” to the operational status column 62D of the action table 62. Data “complete” is thereby stored in the common DB 14A for the index “operational status”, and the determination result of the step 146 of FIG. 12 becomes affirmative determination.

When the determination result of step 240 is negative determination, at step 244 the determination section 90 determines whether or not the number of servers present stored in the number of servers present column 64D1 of the server management table 64 is the value stored in the count column 62E of the action table 62. The value stored in the count column 62E of the action table 62 is the number of managed servers that acquired, or took over, the operation instruction and whose presence was not interrupted during execution. The number of servers present stored in the number of servers present column 64D1 is the number managed server currently present in group A. Thus when the determination result of step 244 is affirmative determination, it can accordingly be determined that all of the managed server present in group A acquired, or took over, the operation instruction and did not complete the processing. In particular, it is possible to determine cases in which the final managed server took over the operation instruction but was not able to complete normally.

When the determination result of step 244 is affirmative determination, at step 248 “execution not possible” is written to the operational status column 62D of the action table 62. Thus the data of “execution not possible” is stored in the common DB 14A for the index “operational status”, and the determination result of step 150 of FIG. 12 becomes negative determination.

When the determination result of step 244 is negative determination, at step 246, the second write section 94 writes “abnormal end” to the operational status column 62D. The data “abnormal end” is thereby stored in the common DB 14A for the index “operational status”, and the determination result of step 150 of FIG. 12 becomes affirmative determination.

Advantageous Effects from Operation Instruction

First Advantageous Effect

As explained above, when the management server 12 wants to execute a given processing on one of the managed servers in group A, the management server 12 writes operation instruction data indicating the processing desired for execution to the instruction column 62C of the action table 62 in the common DB 14A. More precisely, the management server 12 writes the operation instruction indicating the operation desired to be executed on the instruction column 62C of the action table 62 in the common DB 14A, without communicating with any of the managed server of group A. Then, for example, if the operation could not be completed in the managed server 16A that acquired the operation instruction, the other managed server 18A takes over the operation instruction, without involving the management server 12. If the managed server 18A is also not able to complete the processing, then the other managed server 20A takes over the operation instruction, without involving the management server 12. Furthermore, if processing could not be completed in all of the managed servers belonging to the group A, by the management server 12 writing the operation instruction data to the instruction column 62C of the action table 62 stored in the common DB 14B of the other group B, the operation instruction is taken over by the other group B.

Thus even when processing is not completed by the first managed servers that have acquired, or taken over, the operation instruction, the operation instruction is taken over by managed servers in the same or a different group, without the management server 12 communicating with the other managed server. The load on the management server 12 is accordingly reduced. Moreover, the management server 12 does not communication with each of the managed servers, and so the communication volume with each of the managed server is reduced.

Second Advantageous Effect

As described above, when the processing could not be executed by all of the managed server belonging to the group A, the management server 12 writes the operation instruction data to the instruction column 62C of the action table 62 stored in the common DB 14B of the other group B. The operation instruction is thereby taken over by the other group B. This thereby enables transfer of the operation instruction to the other group to be performed easily.

Third Advantageous Effect

The managed servers that acquired, or took over, the operation as described above, writes the execution result to the operational status column 62D of the action table 62 of the common DB 14A, enabling the management server 12 to verify the execution result of the managed servers. Moreover, even if an abnormality occurs in one of the managed servers, since this does not affect another managed server from writing the execution result of its own device to the common DB, the management server is still able to verify the execution result for the operation instruction.

### Modified Example

Explanation has been given in the above exemplary embodiment of creation of a VM as an example of processing instructed to the managed servers. Examples of other processing include, for example, instructing a change in conditions to move the created VM to another managed server. More specifically, examples of the conditions include cases of changing the CPU utilization from 50% to 80%. When the above processing has ended, the target managed server does not move the VM even if the CPU utilization has exceeded 50%, unless it then reaches 80%. Other examples of processing include, for example, an instruction to switch power supply ON/OFF for each of the managed server, or selected managed servers. Consider a case in which the power of a managed server on which a given VM operating is to be switched OFF. The managed server of the move-destination of the VM, operating on a managed server whose power is desired to be switched OFF, is designated in the target server column 62A of the action table 62. By instructing the move of the VM in the instruction column 62C, the management server 12 can move the VM to the designated managed server without communicating with the managed servers. After the VM has been moved, an operation instruction to switch OFF the power may be designated for the move-origin managed server.

Moreover, when moving the VM, for example, sometimes there is no spare resource in the managed servers 16A to 20A belonging to group A, so it is desired to move the VM to one of the managed servers of the other group B. When it is desired to move to one of the managed servers in the other group B, move of the VM may be instructed in the instruction column 62C, without writing anything to the target server column 62A of the action table 62 in the common DB 14B. Even in cases in which it is desired to move to one of the managed servers in the other group B, the management server 12 is able to move the VM without communicating with the managed server.

Moreover, the above processing also includes cases in which a managed server is added to a group. Detailed explanation follows regarding adding a managed server to a group.

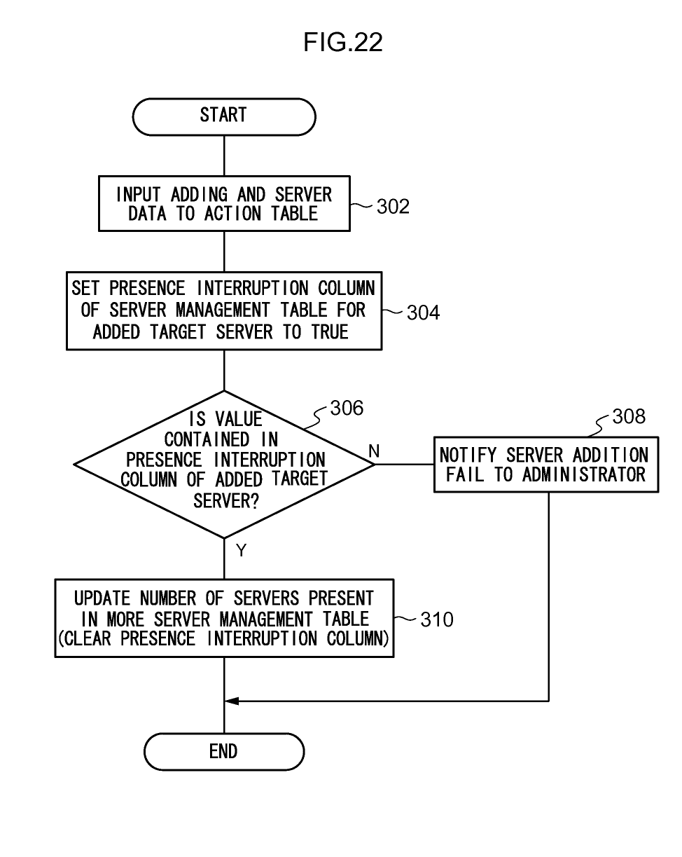

FIG. 22 illustrates a flowchart of server addition processing executed by the management server 12. At step 302 of FIG. 22, the write section 82 writes adding of a new managed server, and data of the new managed server to be added (for example the IP address) to the instruction column 62C of the action table 62 in the common DB 14A. For example, when there is nothing written to the target server column 62A this means that a target managed server has not been designated for execution of managed server addition processing.

For example, take a case in which it is the managed server 16A of group A that first acquired the operation instruction. The determination result of step 234 of FIG. 21 becomes affirmative determination, and the execution section 92 of the managed server 16A executes the instructed processing at step 236. More specifically, data (the IP address) of the common DB 14A is transmitted to the newly added managed server.

The newly added managed server that has received the data of the common DB 14A starts the presence data write processing illustrated in FIG. 11. A storage region to be employed for the newly added managed server is provided in the server management table 64 by the management server 12. This storage region is a storage region similar to the storage region 64A corresponding to the managed server 16A, and is provided with each of the columns corresponding to the server classification column 64A1 to the presence interruption column 64A7. Thus when the newly added managed server starts the presence data write processing illustrated in FIG. 11, the communication time is written to the presence status column corresponding to the newly added managed server.

As stated above, a storage region employed for the newly added managed server is provided to the server management table 64 in the common DB 14A. At step 304 of FIG. 22, the write section 82 writes true to the presence interruption column of the storage region corresponding to the newly added managed server in the server management table 64.

At step 306, the first determination section 74 verifies whether or not there is a value of communication time in the presence status column corresponding to the newly added managed server. When the determination result of step 306 is affirmative determination, it can be determined that the newly added managed server has written the communication time to the presence status column corresponding to its own device. This thereby enables determination that the managed server has been added normally. At step 310, the write section 82 increases the number in the number of servers present column 64D1 by one. The write section 82 also clears the presence interruption column of the storage region corresponding to the newly added managed server in the server management table 64.

However, when the determination result of step 306 is negative determination, it can be determined that the newly added managed server has not written the communication time to the presence interruption column corresponding to its own device. This thereby enables determination that addition of the managed server has failed. At step 308, the communication section 78 notifies the administrator that addition of the managed server has failed. More specifically, the communication section 78 controls the display processor 40 to display on the monitor 32 that addition of the managed server has failed.

As explained above, the management server 12 writes the operation instruction data instructing addition of the managed server to the instruction column 62C of the action table 62 of the common DB 14A. More specifically, the management server 12 writes the operation instruction data to instruct the addition to the instruction column 62C of the action table 62 of the common DB 14A without communicating with any of the managed server of group A. For example, if the managed server 16A is not able to complete processing, the other managed server 18A takes over the operation instruction, without involving the management server 12. If the managed server 18A is also not able to complete the processing, then the other managed server 20A takes over the operation instruction, without involving the management server 12. Thus even when processing is not completed by the first managed server that has acquired, or taken over, the operation instruction, the operation instruction is taken over by another managed server without the management server 12 communicating with the other managed server. This thereby enables the load on the management server 12 to be reduced.

Overall Advantageous Effects

First Advantageous Effect

In the above exemplary embodiment, the management server 12 is able to reduce the load on the management server 12 when verifying the presence of plural managed server and when instructing executing of processing, enabling the management server 12 to manage more managed servers that with conventional technology.

In conventional technology in which a representative server in each layer manages servers or lower layers, for example, in cases in which an abnormality occurs in the representative server of an intermediate layer managing the processing of each of plural servers in the lowest layer, the management server is not able to acquire the data of the plural servers in the lowest layer. However, in the present exemplary embodiment, since the managed server are not managed hierarchically, and common DBs are employed to manage each of the managed server, so the situation does not arise of a managed server that cannot be managed.

In conventional technology for mutual management of plural servers belonging to the same group, in order to acquire the latest data, the management server accesses each of the servers and changes the execution condition of all of the servers individually in order to change the execution condition (such as to 80% as in the example above). However, in the present exemplary embodiment, the common DBs are employed to manage each of the managed servers, and so the management server 12 does not communicate with the managed servers.

Thus the present exemplary embodiment enables the load on the management server 12 to be reduced while solving issues with conventional technology.

Second Advantageous Effect

In conventional technology, a management server communicates with each of the servers, and so this leads to a heavy load on the management server and to it taking time to process data acquired from all of the servers, with a deterioration in management performance of the management server. There is accordingly a need to increase the number of management servers in order to raise management performance. In contrast thereto, in the present exemplary embodiment, due to being able to reduce the load on the management server 12, the number of the management servers 12 for appropriately managing the same number of managed server can be reduced in comparison to conventional technology. Thus by being able to reduce the number of the management servers 12, the configuration of the server management system 10 can be simplified from hitherto. The cost of building the server management system 10 can also be reduced in comparison to conventional technology.

One aspect of the technology disclosed herein has the advantageous effect of enabling a management device to reliably manage plural managed devices while reducing the load of the management device.

All publications, patent applications and technical standards mentioned in the present specification are incorporated by reference in the present specification to the same extent as if the individual publication, patent application, or technical standard was specifically and individually indicated to be incorporated by reference patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A management system comprising a plurality of managed devices, a management device that manages each of the plurality of managed devices, and a storage device that is provided separately from the plurality of managed devices and the management device, and is commonly employed by the plurality of managed devices and the management device, wherein:
the plurality of managed devices each respectively write status data, indicating a status of the respective managed device, to the storage device at a specific timing; and
the management device manages the status of each of the managed devices by verifying the status data written to the storage device at a timing according to the specific timings.

2. The management system of claim 1, wherein:
each of the plurality of managed devices write presence data, indicating that the respective managed device is present, to the storage device as the status data; and
the management device verifies the presence status of each of the plurality of managed devices based on the presence data written to the storage device.

3. The management system of claim 1, wherein:
each of the plurality of managed devices writes operation data, indicating an operational status of the respective managed device, to the storage device as the status data; and
the management device verifies the operational status of the plurality of managed devices based on the operation data written to the storage device.

4. The management system of claim 3, wherein:
the management device writes to the storage device operation instruction data to execute processing on one of the plurality of managed devices; and
at specific timings each of the plurality of managed devices verifies the operation instruction data that has been written to the storage device, and when one of the plurality of managed devices executes processing indicated by the operation instruction data, the managed device that executes the processing writes an execution status and an execution result of the processing to the storage device as the operation data.

5. The management system of claim 4, wherein:
to designate a managed device to execute the processing, the management device writes to the storage device identification data for identifying the managed device to be designated, associated with the operation instruction data; and
the respective managed device executes processing indicated by the operation instruction data when identification data associated with verified operation instruction data indicates the respective managed device, and when there is no identification data associated with the verified operation instruction data and no operation data written to the storage device indicating that processing indicated by the operation instruction data is being executed by another managed device.

6. The management system of claim 1, wherein:
to add a managed device, the management device writes to the storage device operation instruction data to instruct addition of a managed device; and
the respective managed device that operates according to the operation instruction data instructing addition of a managed device transmits data of the storage device, employed by the respective managed device, to the added managed device.

7. The management system of claim 1, wherein:
the plurality of managed devices are classified into a plurality of groups, and the storage device is provided for each of the groups for common usage by each of the managed devices belonging to each of the respective groups and by the management device; and
when it is verified, based on operational status written to the storage device, that instructed processing is not completed by a group corresponding to a storage device to which operation instruction data was written, the management device writes the operation instruction data to a storage device corresponding to another group.

8. A management device that manages a plurality of managed devices, the management device comprising:
a processor that executes a process, the process comprising:
acquiring status data indicating a status of each of the managed devices written at specific timings by each of the managed devices to a storage device that is provided separately from the plurality of managed devices and the management device and is commonly employed by the plurality of managed devices and the management device, by acquiring the status data at a timing according to the specific timings; and
determining a status of each of the managed devices based on the acquired status data.

9. The management device of claim 8, wherein:
as the status of each of the managed devices, a presence status of each of the plurality of managed devices is determined based on presence data indicating that the respective managed device is present written to the storage device as the status data by the respective plurality of managed devices.

10. The management device of claim 8, wherein:
as the status data of each of the managed devices, an operational status of each of the plurality of managed devices is determined based on operation data indicating the operational status of the respective managed device written to the storage device as status data by the respective plurality of managed devices.

11. The management device of claim 8, the process further comprising:
writing to the storage device operation instruction data to execute processing on one of the plurality of managed devices.

12. The management device of claim 11, wherein
to designate a managed device to execute the processing, when writing the operation instruction data to the storage device, identification data for identifying the managed device to be designated is written to the storage device associated with the operation instruction data.

13. The management device of claim 11, wherein
to add a managed device, operation instruction data to instruct addition of a managed device is written to the storage device as the operation instruction data.

14. The management device of claim 11, wherein:
the plurality of managed devices are classified into a plurality of groups, and the storage device is provided for each of the groups for common usage by each of the managed devices belonging to each of the respective groups and by the management device; and
in the writing of the operation instruction data to a storage device, when it is verified, based on operational status written to the storage device, that instructed processing has not been completed by a group corresponding to a storage device to which operation instruction data was written, the operation instruction data is written to a storage device corresponding to another group.

15. A non-transitory recording medium storing a management program that causes a computer to execute a process, the process comprising:
for a storage device that is provided separately from a plurality of managed devices and from a device itself managing the plurality of managed devices and that is commonly employed by the plurality of managed devices and the device itself, managing a status of each of the managed devices by verifying status data, indicating a status of each of the managed devices that has been written to the storage device at specific respective timings by each of the plurality of managed devices, at a timing according to the specific timings.

16. A managed device managed by a management device, the managed device comprising:
a processor that executes a process, the process comprising:
writing status data indicating a status of the managed device itself at a specific timing to a storage device that is provided separately from the management device and a plurality of managed devices including the managed device itself and that is commonly employed by the management device and the plurality of managed devices.

17. The managed device of claim 16, wherein:
presence data indicating that the managed device itself is present is written to the storage device as the status data.

18. The managed device of claim 16, wherein:
operation data indicating an operational status of the managed device itself is written to the storage device as the status data.

19. A non-transitory recording medium storing a managed target program that causes a computer to execute a process, the process comprising:
for a storage device that is provided separately from a plurality of managed devices including a device of the managed target process itself and a management device managing the plurality of managed devices and that is commonly employed by the plurality of managed devices and the management device, writing status data indicating a status of the device itself to the storage device at a specific timing.
